(19) United States
(12) Patent Application Publication
(10) Pub. No.: US 2025/0307490 A1
(43) Pub. Date: Oct. 2, 2025

(54) SYSTEM AND METHOD FOR PERFORMING SERVER-BASED DESIGN FOR EXCELLENCE (DFX) ANALYSIS ON 3-DIMENSIONAL (3D) MODELS

(71) Applicant: HCL Technologies Limited, New Delhi (IN)

(72) Inventors: Romesh Agrawal, Pune (IN); Hetan Mulraj Mithawala, Mumbai (IN)

(21) Appl. No.: 19/074,327

(22) Filed: Mar. 8, 2025

(30) Foreign Application Priority Data
Mar. 28, 2024 (IN) 202411025080

(51) Int. Cl. G06F 30/17

(52) U.S. Cl. CPC G06F 30/17

(57) ABSTRACT

This disclosure relates to method and system for performing server-based Design for Excellence (DFX) analysis on 3-dimensional (3D) models. The method may include receiving an execution request and a set of execution parameter values corresponding to a DFX analysis of a 3D Computer Aided Design (CAD) model from a user device; adding the DFX analysis to an execution queue. The execution queue may include a plurality of DFX analyses received for server-based execution from a plurality of user devices. The method may further include assigning one of a plurality of execution servers to perform an execution of the DFX analysis from the execution queue; and triggering the one of the plurality of execution servers to execute the DFX analysis of the 3D CAD model based on the set of execution parameter values via a DFX batch application implemented in silent mode.

### TECHNICAL FIELD

The disclosure generally relates to Design for Excellence (DFX) analysis, and more particularly to a system and method for performing server based DFX analysis on 3D models.

### BACKGROUND

Design for excellence (DFX) is a set of methods, standards, and guidelines for better product development at the concept design phase itself. DFX may include Design for Manufacturing (DFM), Design for Assembly (DFA), Design for Inspection (DFI), Design for Cost (DFC), Design for Reliability (DFR), Design for Serviceability (DFS), etc. It is an engineering practice, which helps to design products that are easy to manufacture and assemble, reduce product cost and time-to-market. DFX helps to find potential down-stream issues in the early stage of design and development, so that corrective actions can be taken at early phases of product design. This helps to improve product quality, reduce cost and time-to-market.

Industries across different sectors are expanding and creating more complex designs, and global competitions are also causing organizations to build higher quality products at a faster pace. Every organization strives to achieve these goals, and DFX practice plays an important role in achieving these goals by helping in finding potential manufacturing and assembly related issues at an early stage of product development cycle. DFX also helps organizations to know if there is any opportunity to reduce the cost of the product at the initial stages of design by using some good cost-to-design practices.

However, DFX analysis is a computation-intensive and time-consuming process which requires lot of computing power and resources as it needs to process the geometry of 3D CAD model and execute many geometrical heuristics, especially when dealing with very large size 3D CAD model (CAD part or assemblies). Computer hardware resources (CPU, RAM, Hard disk etc.) required for DFX analysis and analysis time depends on various factors like 3D CAD model size, CAD model complexity, number of components in assembly model, type of analysis, numbers of DFX rules, and type of DFX rules etc.

Benefits of DFX analysis can be maximized when it is used at an early stage of design. However, designers who work on machines with limited computing power are unable to perform DFX analysis on very large 3-Dimensional (3D) models (of size in range of 50 MB to 5 GB) either due to hardware resource constraints or due to long waiting time for completion of DFX analysis (which may be from couple of hours to couple of days). As a result, DFX analysis may not be performed at the early stage of design which leads to identification of potential issues at later stages. This impacts product quality, increase in lead time, and product cost.

Many times, system level DFX analyses are not performed due to above mentioned reasons. This leads to downstream assembly and service-related issues which are difficult and costly to fix. Designers generally work on part level or module level sub-assemblies, and any modification on these sub-assemblies can impact higher level assemblies at system level. System level assembly file sizes are huge and can go up to 10-15 GBs. DFX analysis for system level checks (e.g., fastener accessibility, fastener clearance, fastener alignment, interreference/clearance between components, etc.) is very difficult or impossible for designers (and even for engineering team for DFX analysis) to execute on their machines.

Thus, the techniques in the present state of art fail to address the problem of efficiently performing DFX analysis for large 3D models (e.g., system level DFX analyses).

### SUMMARY

In one embodiment, a method for performing server-based Design for Excellence (DFX) analysis on 3-dimensional (3D) models is disclosed. In one example, the method may include receiving, by a DFX master server, an execution request and a set of execution parameter values corresponding to a DFX analysis of a 3D Computer Aided Design (CAD) model from a user device. The method may further include adding, by the DFX master server, the DFX analysis to an execution queue. The execution queue may include a plurality of DFX analyses received for server-based execution from a plurality of user devices. The method may further include assigning, by the DFX master server, one of a plurality of execution servers to perform an execution of the DFX analysis from the execution queue. The method may further include triggering, by the DFX master server, the one of the plurality of execution servers to execute the DFX analysis of the 3D CAD model based on the set of execution parameter values via a DFX batch application implemented in silent mode.

In one embodiment, a system for performing server-based DFX analysis on 3D models may be disclosed. In one example, the system may include a processor and a computer-readable medium communicatively coupled to the processor. The computer-readable medium may store processor-executable instructions, which, on execution, may cause the processor to receive an execution request and a set of execution parameter values corresponding to a DFX analysis of a 3D CAD model from a user device. The processor-executable instructions, on execution, may further cause the processor to add the DFX analysis to an execution queue. The execution queue may include a plurality of DFX analyses received for server-based execution from a plurality of user devices. The processor-executable instructions, on execution, may further cause the processor to assign one of a plurality of execution servers to perform an execution of the DFX analysis from the execution queue. The processor-executable instructions, on execution, may further cause the processor to trigger the one of the plurality of execution servers to execute the DFX analysis of the 3D CAD model based on the set of execution parameter values via a DFX batch application implemented in silent mode.

In one embodiment, a non-transitory computer-readable medium storing computer-executable instructions for performing server-based Design for Excellence (DFX) analysis on 3D models is disclosed. In one example, the stored instructions, when executed by a processor, may cause the processor to perform operations including assigning one of a plurality of execution servers to perform an execution of the DFX analysis from the execution queue. The operations may further include assigning one of a plurality of execution servers to perform an execution of the DFX analysis from the execution queue. The operations may further include triggering the one of the plurality of execution servers to execute the DFX analysis for the 3D CAD model based on the set of execution parameter values via a CAD application implemented in silent mode.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A and 1B illustrate a functional block diagram of an exemplary system for performing server-based Design for Excellence (DFX) analysis on 3-dimensional (3D) models, in accordance with some embodiments of the present disclosure.

FIG. 2 is a flow diagram of an exemplary process for performing server-based DFX analysis on 3D models, in accordance with some embodiments of the present disclosure.

FIG. 3 illustrates a block diagram of an exemplary recommender system for recommending local DFX analysis or server-based DFX analysis, in accordance with some embodiments of the present disclosure.

FIG. 4 illustrates an exemplary DFX analysis results dashboard, in accordance with some embodiments of the present disclosure.

FIG. 5 illustrates a functional block diagram of an exemplary DFX master server, in accordance with some embodiments of the present disclosure.

FIG. 6 illustrates a functional block diagram of an exemplary DFX execution server, in accordance with some embodiments of the present disclosure.

FIG. 7 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

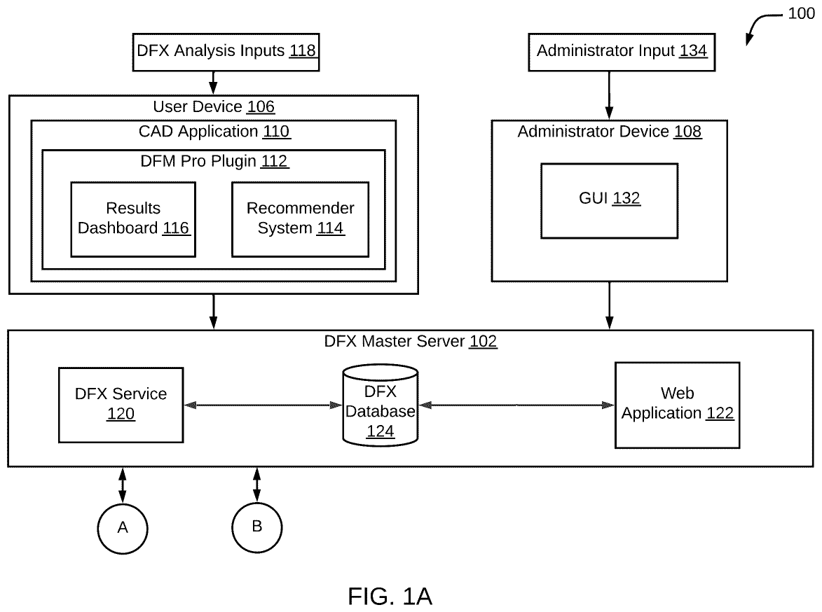

Referring now to FIGS. 1A and 1B, a functional block diagram of an exemplary system 100 for performing server-based Design for Excellence (DFX) analysis on 3-dimensional (3D) models is illustrated, in accordance with some embodiments of the present disclosure. The system 100 may include a DFX master server 102, a plurality of DFX execution servers (such as a DFX execution server 104A and a DFX execution server 104B), a plurality of user devices (such as a user device 106), and an administrator device 108.

The user device 106 may be accessed by a user. By way of an example, the user device 106 may be a desktop, a laptop, or any other computing device. The user device 106 may implement a Computer-Aided Design (CAD) application 110. The CAD application 110 may host a Design for Manufacturing (DFM)

Pro plugin 112. It should be noted that the DFM Pro plugin 112 is integrated with the CAD application 110 and may be used to identify and provide recommendations to resolve potential downstream DFX issues. The DFM Pro plugin 112 may include a recommender system 114 and a DFX analysis results dashboard 116.

To perform a DFX analysis of a 3D CAD model, the user may open the 3D CAD model in the CAD application 110 and may launch the DFM Pro plugin 112. The recommender system 114 may be automatically triggered whenever a 3D CAD model is opened in DFM Pro plugin 112. The user may provide DFX analysis inputs 118 to the CAD application 110. The DFX analysis inputs 118 may include a set of execution parameter values. By way of an example, the set of execution parameter values may include DFX rule configuration information, 3D model parameter values, user inputs, and hardware information. The DFX rule configuration information may be provided in form of an XML file that may store configurations of DFX rules which are to be validated.

The recommender system 114 may generate an execution recommendation for the DFX analysis based on the set of execution parameter values using a heuristic algorithm or a Machine Learning (ML algorithm). The execution recommendation may be indicative of one of a user device-based execution or a server-based execution. If the execution recommendation is indicative of the user device-based execution, then the DFX analysis may be executed in the user device 106. In other words, the user may continue to perform the DFX analysis in the user device 106 with interactive mode analysis.

On the other hand, if execution recommendation is indicative of the server-based execution, the DFM Pro plugin 112 may send an execution request for the DFX analysis and the DFX analysis inputs 118 to the DFX master server 102. It may be noted that the user may submit more than one execution request. Each execution request may be submitted separately to the DFX master server 102. The DFX master server 102 may implement a DFX service 120 and a web application 122. Further, the DFX master server 102 may include a DFX database 124. The DFX database 124 may be accessible by the DFX service 120 and the web application 122.

The DFX service 120 may receive the execution request and the DFX analysis inputs 118 from the DFM Pro plugin 112. Further, the DFX service 120 may add the execution request for the DFX analysis to an execution queue in the DFX database 124 along with the DFX analysis inputs 118. The DFX service 120 may send a request submission notification to the DFM Pro plugin 112 running on the user device 106. Further, the DFX service 120 may select the execution request from the execution queue and may assign the DFX execution server 104A to perform an execution of the DFX analysis. The selection of the execution request may be based on a priority order (i.e., based on a priority assigned to the execution request). Alternatively, the selection of the execution request may be based on chronological order (i.e., based on a time of reception of the execution request by the DFX service 120).

For ease of illustration, the DFX service 120 is shown as a single module. However, in some embodiments, a first DFX service may receive and add the execution request to the execution queue and a second DFX service may assign the DFX execution server 104A to execute the DFX analysis.

The DFX execution server 104A may implement a DFX execution service 126A. The DFX execution service 126A may start a DFX batch application 128A. The DFX batch application 128A may be a silent mode DFX analysis application. The DFX batch application 128A may provide the DFX analysis inputs 118 and the 3D model to a DFX batch. The DFX batch may internally use a CAD Application 130A in silent mode to execute the DFX analysis. It should be noted that the DFX execution service 126A may facilitate execution of multiple DFX analyses in parallel through implementation of multiple DFX batch applications (e.g., a DFX batch application 128B) and CAD applications (e.g., a CAD application 130B) in parallel. Once execution is completed, the DFX execution service 126A may send a DFX analysis status and DFX analysis results to the DFX service 120. The DFX service 102 may provide and store an updated DFX analysis status along with the DFX analysis results in the database 124.

Similarly, the DFX execution server 104B may implement a DFX execution service 126B that may start a DFX batch application 128C and a DFX batch application 128D in silent mode connected to a CAD application 130C and a CAD application 130D. respectively (which are also implemented in silent mode) to execute other DFX analyses. Before scheduling an execution, the DFX service 120 also checks if sufficient resources (CPU, RAM, etc.) are available on a DFX execution server (e.g., the DFX execution server 104A or the DFX execution server 104B) for DFX analysis. In other words, prior to assigning an execution server for DFX analysis, the DFX service 120 may determine execution server availability based on a current computational load of the execution server. There is no limit on the number of DFX execution servers. It depends on the number of DFX analyses to be processed at a time and may be decided on a case-to-case basis.

An administrator may access the web application 122 from the administrator device 108 via a GUI 132. The administrator device 108 may be a computing device where the administrator has logged in. The administrator may be a user role with rights and privileges to access the web application 122. The web application 122 may enable the administrator to configure DFX execution servers (such as the DFX execution server 104A and the DFX execution server 104B) or add one or more new execution servers based on a modification command received as an administrator input 134. The web application 122 can also be used to view and monitor statuses of the execution requests in the execution queue. For example, the status may be pending, completed, or under analysis. The web application 122 may retrieve information of the statuses from the DFX database 124. The DFX database 124 may store details of the execution requests which are populated by the DFX service 120.

The results dashboard 116 implemented by the DFM Pro plugin 112 may show the execution request information (like request date, request time, 3D CAD file name, rule configuration file name, status of the DFX analysis (e.g., queued, running, successful, or failed), and option to import results of the DFX analysis through an importable results file) for one or more DFX analysis submitted by the user. Thus, while the web application 122 may provide statuses of all the execution requests to the administrator device 108, the results dashboard 116 may only show the statuses of the one or more DFX submitted by the user. The user may import the results of the successfully executed DFX analysis from the results dashboard 116 through the importable results file and interact seamlessly as the importable results file is run in an interactive mode.

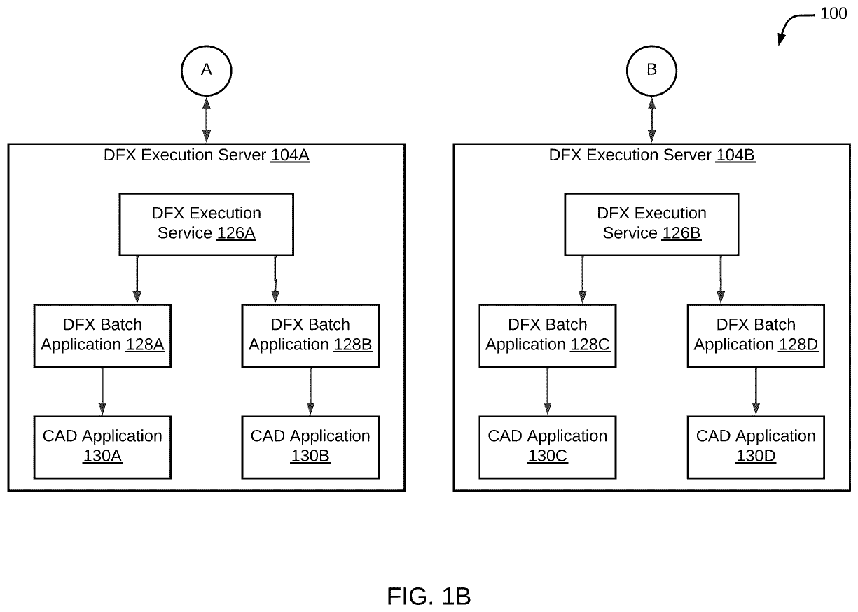

Referring now to FIG. 2, an exemplary process 200 for performing server based DFX analysis on 3D models is depicted via a flowchart, in accordance with some embodiments of the present disclosure. The process 200 may be implemented by the DFX master server 102 of system 100. The process 200 may include receiving, by the recommender system 114, the set of execution parameter values corresponding to the DFX analysis. The set of execution parameter values comprises DFX rule configuration information, 3D model parameter values, user inputs, and hardware information. Further, the process 200 may include generating, by the recommender system 114, an execution recommendation for the DFX analysis based on the set of execution parameter values using a heuristic algorithm or a Machine Learning (ML) algorithm. The ML algorithm may be a classification algorithm The execution recommendation may correspond to one of a user device-based execution or a server-based execution. It should be noted that the recommender system 114 may be implemented via the DFM Pro plugin 112 on the user device 106 or alternatively, the recommender system 114 may be implemented on the DFX master server 102. When implemented on the user device 106, the processing may be faster and may add less computational load on the DFX master server 102.

The process 200 may include receiving, by the DFX service 120, an execution request and a set of execution parameter values corresponding to a DFX analysis of a 3D CAD model from a user device (for example, the user device 106), at step 202.

The process 200 may include adding, by the DFX service 120, the DFX analysis to an execution queue, at step 204. The execution queue may include a plurality of DFX analyses received for server-based execution from a plurality of user devices.

The process 200 may include assigning, by the DFX service 120, one of a plurality of execution servers (for example, the DFX execution server 104A or the DFX execution server 104B) to perform an execution of the DFX analysis from the execution queue, at step 206. In some embodiments, prior to assigning the one of the plurality of execution servers, the process 200 may include determining, by the DFX service 120, execution server availability based on a current computational load of the one of the plurality of execution servers.

The process 200 may include triggering, by the DFX service 120, the one of the plurality of execution servers to execute the DFX analysis of the 3D CAD model based on the set of execution parameter values via a DFX batch application (for example, the DFX batch application 128A, the DFX batch application 128B, the DFX batch application 128C, or the DFX batch application 128D) implemented in silent mode, at step 208. Similarly, the process 200 may include triggering, by the DFX service 120, the plurality of execution servers to execute the plurality of DFX analyses received for the server-based execution in the execution queue via a plurality of DFX batch applications implemented in silent mode.

Further, the process 200 may include populating, by the DFX service 120) a results dashboard (such as the results dashboard 116) on the user device, at step 210. The results dashboard may include a status and execution request information corresponding to each of one or more DFX analyses corresponding to the user device. The process 200 may include upon completion of the execution, receiving, by the DFX service 120, results of the DFX analysis from the one of the plurality of execution servers, at step 212. The process 200 may include generating, by the DFX service 120, an importable results file including the results of the DFX analysis, at step 214. The process 200 may include updating, by the DFX service 120, the status of the DFX analysis in the results dashboard to indicate completion of the execution, at step 216. The process 200 may include providing, by the DFX service 120, the importable results file in the results dashboard, at step 218.

Additionally, the process 200 may include populating, by the DFX service 120, a web application (such as the web application 122) on an administrator device (such as the administrator device 108). A GUI of the web application includes the execution queue (i.e., the execution requests received from each of the plurality of user devices). The process 200 may include receiving, by the DFX service 120, a modification command corresponding to the plurality of execution servers from the administrator device via the web application. The modification command may correspond to addition of one or more new execution servers or configuration of the plurality of execution servers. The process 200 may include updating, by the DFX service 120, the plurality of execution servers based on the modification command.

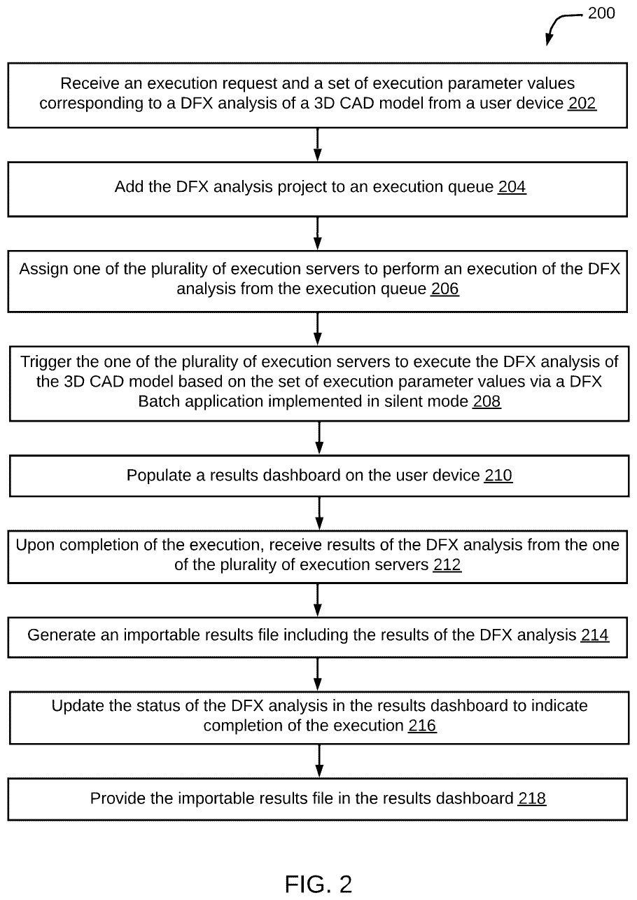

Referring now to FIG. 3, a block diagram of an exemplary recommender system 300 for recommending local DFX analysis or server-based DFX analysis is illustrated, in accordance with some embodiments of the present disclosure. The recommender system 300 may be analogous to the recommender system 114. The recommender system 300 may suggest the user whether the 3D model is a good candidate for local DFX analysis or for server-based DFX analysis. This ensures only those DFX analysis execution requests which cannot be processed on the user device 106 or which may take significant time to execute on the user device 106, are sent to server.

The recommender system 300 may suggest if a specific DFX analysis is to be performed on a DFX execution server (via the DFX master server 102). The recommender system 300 may use DFX rule configuration information 302, 3D CAD model parameter values 304, user inputs 306 for the DFX analysis, and hardware information 308 of the user device.

The recommender system 300 may extract the DFX rule configuration information 302 like number of rules and types of rules from a DFX rule configuration file. The recommender system 300 may also extract the 3D model parameter values 304 like model size, number of components, number of fasteners/cables/tubes, number of faces, and number of edges from the 3D CAD model which is opened in a CAD application (such as the CAD application 130A). The recommender system 300 may get the user inputs 306 like process and type of analysis i.e., full or partial, from the user device. The recommender system 300 may also extract the hardware information 308 of the user device like CPU speed, number of cores, and RAM, that may have an impact the DFX analysis time, from the user device.

The recommender system 300 may implement a heuristic algorithm or an ML algorithm and based on the DFX rule configuration information 302, the 3D CAD model parameter values 304, the user inputs 306 for the DFX analysis, and the hardware information 308 of the user device, may generate an execution recommendation (i.e., whether the DFX analysis should be performed on the DFX execution server or on the user device). As will be appreciated, some rules (e.g., interference between components, clearance between components, fastener clearance, tube clearance, cable interference, etc.) may require significant processing compared to other rules which are query-based and may not require any computation. Hence, type of rules also needs to be considered while recommending server-based analysis.

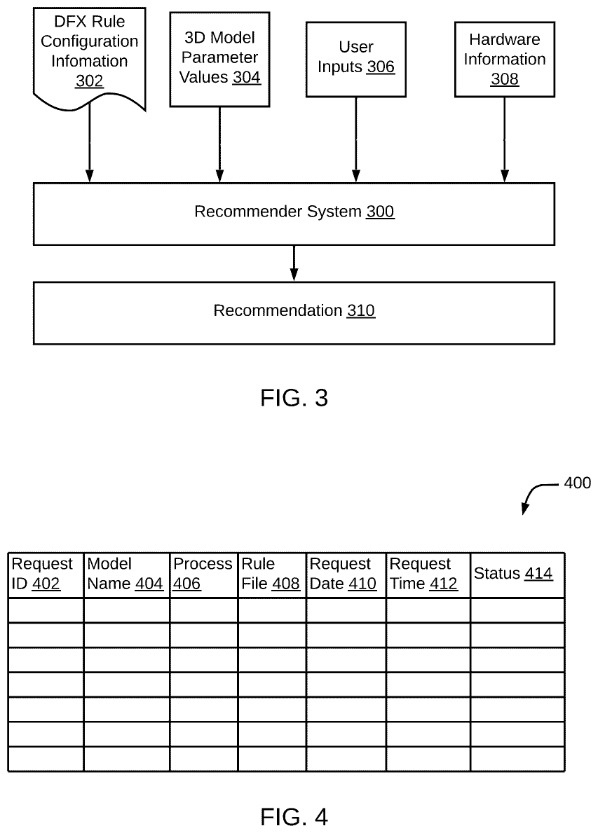

Referring now to FIG. 4, an exemplary results dashboard 400 is illustrated, in accordance with some embodiments of the present disclosure. The result dashboard 400 may provide information associated with each of one or more execution requests submitted for the user. The results dashboard 400 may be analogous to the results dashboard 116. For each of the one or more execution requests, the results dashboard 400 may include a request ID 402, a model name 404, a process 406, a rule file 408, a request date 410, a request time 412, and a status 414. The request ID 402 is a unique ID created for every request. The model name 404 is file name of the 3D CAD model for which the DFX analysis is performed. The process 406 and the rule file 408 are provided as an input by the user. The request date 410 and the request time 412 are also captured which can be referred by the user to know when a particular request was sent to the DFX master server 102. The status 414 provides a current status of a submitted execution request. The status 414 may be one of “queued”, “analysis is in progress”, “analysis is successful”, “analysis is paused”, “analysis is cancelled”, or “analysis failed”. The results dashboard 400 may also provide an option to import the results of DFX analyses which are successfully completed through a importable results file.

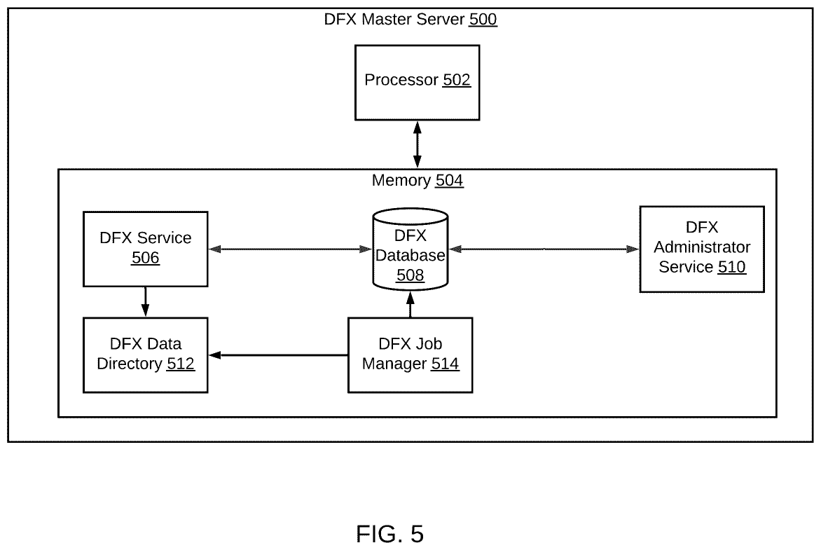

Referring now to FIG. 5, a functional block diagram of an exemplary DFX master server 500 is illustrated, in accordance with some embodiments of the present disclosure. The DFX master server 500 may be analogous to the DFX master server 102. The DFX master server 500 may include a processor 502 communicatively coupled to a memory 504. The memory 504 may include a DFX service 506 (analogous to the DFX service 120), a DFX database 508 (analogous to the DFX database 124), a DFX administrator service 510, a DFX data directory 512, and a DFX job manager 514.

The DFX service 506 and the DFX administrator service 510 are exposed to clients (such as the user device 106 and the administrator device 108). The DFX service 506 may receive an execution request for new DFX analysis from the user device, a status request for submitted execution requests from the user device, or result data for completed analysis from an execution server (such as the execution server 104A).

For a new execution request, input files are downloaded in the DFX data directory 512 through the DFX service 506. Further, the DFX service 506 adds the new execution request to the execution queue in the DFX database 508 along with all associated input information. For a status request for a submitted execution request, then the DFX service 596 may retrieve all information associated with the execution request (e.g., current status) from the DFX database 508 and send the retrieved information back to the user device. For a request for results of a DFX analysis, then the DFX service 506 may retrieve all information associated with the DFX analysis from the DFX database 508. The results file corresponding to the DFX analysis may be taken by the DFx service 506 from the DFX data directory 512 and sent to the user device.

The DFX job manager 514 may go through the execution queue stored in the DFX database 508 and may pull a new execution request from the execution queue. The DFX job manager 514 may retrieve all information associated with the execution request from the DFX database 508 and associated input files from the DFX data directory 512. Further, the DFX job manager 514 may schedule the DFX analysis on an execution server (such as the execution server 104A). The DFX job manager 514 may also check if the assigned DFX execution server has enough resources to process the new execution request. If not, then the DFX job manager 514 may wait till resources are released after completing an on-going DFX analysis.

The DFX master server 500 may also provide DFX administrator service 510 for an administrator to add/remove, enable/disable, and configure DFX execution servers through an administrator device (such as the administrator device 108). The DFX administrator service may add/remove/update this information in the DFX database 508.

It should be noted that all such aforementioned modules 506-514 may be represented as a single module or a combination of different modules. Further, as will be appreciated by those skilled in the art, each of the modules 506-514 may reside, in whole or in parts, on one device or multiple devices in communication with each other. In some embodiments, each of the modules 506-514 may be implemented as dedicated hardware circuit comprising custom application-specific integrated circuit (ASIC) or gate arrays, off-the-shelf semiconductors such as logic chips, transistors, or other discrete components. Each of the modules 506-514 may also be implemented in a programmable hardware device such as a field programmable gate array (FPGA), programmable array logic, programmable logic device, and so forth. Alternatively, each of the modules 506-514 may be implemented in software for execution by various types of processors (e.g., processor 504). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for performing server-based DFX analysis on 3D models. For example, the exemplary system 100 and the associated DFX master server 102 may perform server-based DFX analysis on 3D models by the processes discussed herein. In particular, as will be appreciated by those of ordinary skill in the art, control logic and/or automated routines for performing the techniques and steps described herein may be implemented by the system 100 and the associated DFX master server 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

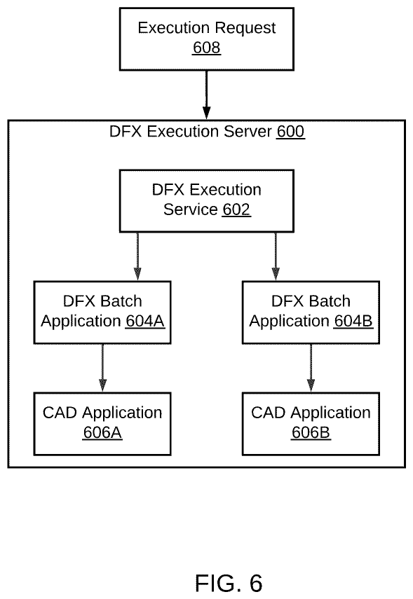

Referring now to FIG. 6, a functional block diagram of an exemplary execution server 600 is illustrated, in accordance with some embodiments of the present disclosure. The execution server 600 may be analogous to the execution server 104A or the execution server 104B. The DFX execution server 600 may process one or more DFX analyses concurrently. The DFX execution server may include a DFX execution service 602, one or more DFX batch applications (such as a DFX batch application 604A and a DFX batch application 604B), and one or more associated CAD applications (such as a CAD application 606A and a CAD application 606B).

The DFX execution service 602 may receive an execution request 608 from the DFX service 506 running on the DFX master server 500. The DFX execution service 602 may initiate a DFX batch application (e.g., the DFX batch application 606A) for each execution request it receives. The DFX batch application 606A internally also starts an associated CAD application (in this case, the CAD application 606A) to load and analyze the 3D CAD model. Once the DFX analysis is completed, the DFX execution service 602 may sends the status and the results file to the DFX service 506.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

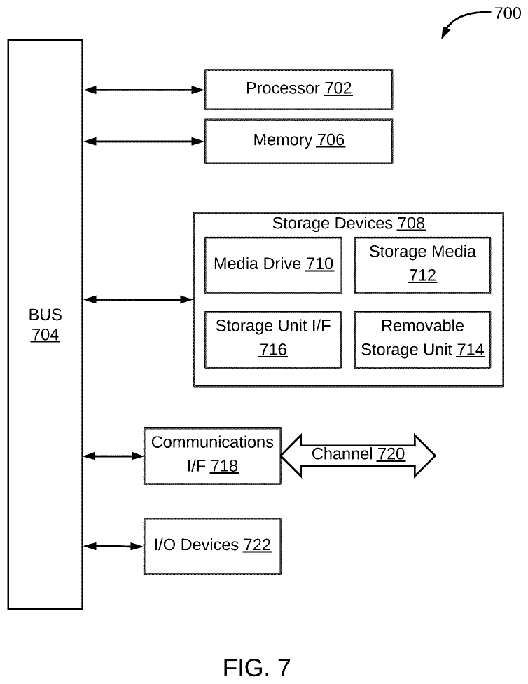

The disclosed methods and systems may be implemented on a conventional or a general-purpose computer system, such as a personal computer (PC) or server computer. Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication medium. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during execution of instructions to be executed by the processor 702. The computing system 700 may likewise include a read only memory (“ROM”) or other static storage device coupled to bus 704 for storing static information and instructions for the processor 502.

The computing system 700 may also include a storage devices 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 712 may include, for example, a hard disk, magnetic tape, flash drive, or other fixed or removable medium that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro-USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via channel 720. Channel 720 may carry signals and may be implemented using a wireless medium, wire or cable, fiber optics, or another communications medium. Some examples of channel 720 may include a phone line, a cellular phone link, an RF link, a Bluetooth link, a network interface, a local or wide area network, and other communications channels.

The computing system 700 may further include Input/Output (I/O) devices 722. Examples may include a display, keypad, microphone, audio speakers, vibrating motor, LED lights, etc. The I/O devices 722 may receive user input and display an output of the computation performed by the processor 702. In this document, the terms “computer program product” and “computer-readable medium” may be used generally to refer to media such as, for example, memory 706, storage devices 708, the removable storage unit 714, or signal(s) on channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

Various embodiments provide method and system for performing server-based DFX analysis on 3D models. The disclosed method and system may receive an execution request and a set of execution parameter values corresponding to a DFX analysis of a 3D CAD model from a user device. Further, the disclosed method and system may add the DFX analysis to an execution queue in a database. The execution queue comprises a plurality of DFX analyses received for server-based execution from a plurality of user devices; Moreover, the disclosed method and system may assign one of a plurality of execution servers to perform an execution of the DFX analysis from the execution queue Thereafter, the disclosed method and system may executing, by the one of the plurality of execution servers, the DFX analysis for the 3D CAD model based on the set of execution parameter values via a CAD application implemented in silent mode.

Thus, the disclosed method and system try to overcome the technical problem of performing server based DFX analysis on 3D models. In this method and system provide the user can perform DFX analysis on large and complex 3D models on servers with high computing power which is otherwise not possible due to limited hardware capacity on user devices. Users can get the recommendation for interactive, and server based DFX analysis. The method and system provide for seamless integration of offline/server-based DFX analysis with interactive mode DFX analysis which gives same user experience as interactive mode. User can continue the work after submitting the DFX analysis request as CAD application is not blocked for DFX analysis which can increase user's throughput. Users can schedule offline/server-based analysis for complex 3D models with multiple combinations in a very quick time. Server based analysis can be used for DFX automation workflow.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for performing server based DFX analysis on 3D models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for performing server-based Design for Excellence (DFX) analysis on 3-dimensional (3D) models, the method comprising:
receiving, by a DFX master server, an execution request and a set of execution parameter values corresponding to a DFX analysis of a 3D Computer Aided Design (CAD) model from a user device;
adding, by the DFX master server, the DFX analysis to an execution queue, wherein the execution queue comprises a plurality of DFX analyses received for server-based execution from a plurality of user devices;
assigning, by the DFX master server, one of a plurality of execution servers to perform an execution of the DFX analysis from the execution queue; and
triggering, by the DFX master server, the one of the plurality of execution servers to execute the DFX analysis of the 3D CAD model based on the set of execution parameter values via a DFX batch application implemented in silent mode.

2. The method of claim 1, further comprising populating, by the DFX master server, a results dashboard on the user device, wherein the results dashboard comprises a status and execution request information corresponding to each of one or more DFX analyses corresponding to a user associated with the user device.

3. The method of claim 2, further comprising:
upon completion of the execution, receiving, by the DFX master server, results of the DFX analysis from the one of the plurality of execution servers; and
generating, by the DFX master server, an importable results file comprising the results of the DFX analysis.

4. The method of claim 3, further comprising:
updating, by the DFX master server, the status of the DFX analysis in the results dashboard to indicate completion of the execution; and
providing, by the DFX master server, the importable results file in the results dashboard.

5. The method of claim 1, further comprising:
receiving the set of execution parameter values corresponding to the DFX analysis, wherein the set of execution parameter values comprises DFX rule configuration information, 3D model parameter values, user inputs, and hardware information; and
generating an execution recommendation for the DFX analysis based on the set of execution parameter values using a heuristic algorithm or a Machine Learning (ML) algorithm, wherein the execution recommendation corresponds to one of a user device-based execution or a server-based execution.

6. The method of claim 1, further comprising, prior to assigning the one of the plurality of execution servers, determining, by the DFX master server, execution server availability based on a current computational load of the one of the plurality of execution servers.

7. The method of claim 1, further comprising triggering, by the DFX master server, the plurality of execution servers to execute the plurality of DFX analyses received for the server-based execution in the execution queue via a plurality of DFX batch applications implemented in silent mode.

8. The method of claim 1, further comprising:
populating, by the DFX master server, a web application on an administrator device, wherein a Graphical User Interface (GUI) of the web application comprises the execution queue;
receiving, by the DFX master server, a modification command corresponding to the plurality of execution servers from the administrator device via the web application, wherein the modification command corresponds to addition of one or more new execution servers or configuration of the plurality of execution servers; and
updating, by the DFX master server, the plurality of execution servers based on the modification command.

9. A system for performing server-based Design for Excellence (DFX) analysis on 3-dimensional (3D) models, the system comprising:
a processor; and
a memory communicatively coupled to the processor, wherein the memory stores processor instructions, which when executed by the processor, cause the processor to:
receive an execution request and a set of execution parameter values corresponding to a DFX analysis of a 3D Computer Aided Design (CAD) model from a user device;
add the DFX analysis to an execution queue, wherein the execution queue comprises a plurality of DFX analyses received for server-based execution from a plurality of user devices;
assign one of a plurality of execution servers to perform an execution of the DFX analysis from the execution queue; and
trigger the one of the plurality of execution servers to execute the DFX analysis of the 3D CAD model based on the set of execution parameter values via a DFX batch application implemented in silent mode.

10. The system of claim 9, wherein the processor instructions, on execution, further cause the processor to populate a results dashboard on the user device, wherein the results dashboard comprises a status and execution request information corresponding to each of one or more DFX analyses corresponding to a user associated with the user device.

11. The system of claim 10, wherein the processor instructions, on execution, further cause the processor to:
upon completion of the execution, receive results of the DFX analysis from the one of the plurality of execution servers; and
generate an importable results file comprising the results of the DFX analysis.

12. The system of claim 11, wherein the processor instructions, on execution, further cause the processor to:
update the status of the DFX analysis in the results dashboard to indicate completion of the execution; and
provide the importable results file in the results dashboard.

13. The system of claim 9, wherein the processor instructions, on execution, further cause the processor to:
receive the set of execution parameter values corresponding to the DFX analysis, wherein the set of execution parameter values comprises DFX rule configuration information, 3D model parameter values, user inputs, and hardware information; and
generate an execution recommendation for the DFX analysis based on the set of execution parameter values using a heuristic algorithm or a Machine Learning (ML) algorithm, wherein the execution recommendation corresponds to one of a user device-based execution or a server-based execution.

14. The system of claim 9, wherein the processor instructions, on execution, further cause the processor to, prior to assigning the one of the plurality of execution servers, determine execution server availability based on a current computational load of the one of the plurality of execution servers.

15. The system of claim 9, wherein the processor instructions, on execution, further cause the processor to trigger the plurality of execution servers to execute the plurality of DFX analyses received for the server-based execution in the execution queue via a plurality of DFX batch applications implemented in silent mode.

16. The system of claim 9, wherein the processor instructions, on execution, further cause the processor to:
populate a web application on an administrator device, wherein a Graphical User Interface (GUI) of the web application comprises the execution queue;
receive a modification command corresponding to the plurality of execution servers from the administrator device via the web application, wherein the modification command corresponds to addition of one or more new execution servers or configuration of the plurality of execution servers; and
update the plurality of execution servers based on the modification command.

17. A non-transitory computer-readable medium storing computer-executable instructions for performing server-based Design for Excellence (DFX) analysis on 3-dimensional (3D) models, the computer-executable instructions configured for:
receiving an execution request and a set of execution parameter values corresponding to a DFX analysis of a 3D Computer Aided Design (CAD) model from a user device;
adding the DFX analysis to an execution queue, wherein the execution queue comprises a plurality of DFX analyses received for server-based execution from a plurality of user devices;
assigning one of a plurality of execution servers to perform an execution of the DFX analysis from the execution queue; and
triggering the one of the plurality of execution servers to execute the DFX analysis of the 3D CAD model based on the set of execution parameter values via a DFX batch application implemented in silent mode.

18. The non-transitory computer-readable medium of claim 17, wherein the computer-executable instructions are further configured for populating a results dashboard on the user device, wherein the results dashboard comprises a status and execution request information corresponding to each of one or more DFX analyses corresponding to a user associated with the user device.

19. The non-transitory computer-readable medium of claim 18, wherein the computer-executable instructions are further configured for:
upon completion of the execution, receiving results of the DFX analysis from the one of the plurality of execution servers; and
generating an importable results file comprising the results of the DFX analysis.

20. The non-transitory computer-readable medium of claim 19, wherein the computer-executable instructions are further configured for:
updating the status of the DFX analysis in the results dashboard to indicate completion of the execution; and
providing the importable results file in the results dashboard.
